(19) United States
(12) Patent Application Publication
(10) Pub. No.: US 2026/0017678 A1
(43) Pub. Date: Jan. 15, 2026

(54) Method and system, for analysing rating-based Impact

(71) Applicant: Jody R. Massey, Atlanta, GA (US)

(72) Inventor: Jody R. Massey, Atlanta, GA (US)

(73) Assignee: Jody R Massey, Atlanta, GA (US)

(21) Appl. No.: 18/772,361

(22) Filed: Jul. 15, 2024

(51) Int. Cl. G06Q 30/0202; G06Q 30/0201

(52) U.S. Cl. CPC G06Q 30/0202; G06Q 30/0206

(57) ABSTRACT

A method and system, for determining the impact of online-scores on one or more revenue-streams of interest, by further generating actionable recommendations for improving various aspects of each of the desired revenue-stream/s. Further, estimating future-loss incurred by each of the revenue-stream, in case the generated recommendations are not carried out. Furthermore, more particularly, the object of the present method and system is to primarily assist a user, in estimation/identification of specific damage-areas (issue-categories) and the related future revenue loss, as well as, in generating recommendations, possible fixes, solutions, etc., along with the projected profit/loss attributes, with respect to each of the issue-categories of the one or more desired revenue-stream/s.

### FIELD OF THE INVENTION

The present subject matter, pertains to the field of data-analysis, specifically to methods and systems that leverage, textual-analysis, machine learning techniques, Artificial Intelligence, Natural Language Processing, in order to objectively assess the impact of online-scores of any given revenue-stream. The subject matter further encompasses the generation of a set of actionable recommendations, that primarily address the loss-generating attributes of the revenue-stream, based on the impact analysis of the online-scores. This enables any business, buyer, renter, leaser, retailer, marketer, freelancer, manufacturer, etc., to proactively manage/investigate the online reputation, as well as, the priority-areas to be improved, for any desired revenue-stream, and ultimately optimize/analyse the future revenue-generation, by determining ways of mitigating the potential future-losses.

### BACKGROUND OF THE INVENTION

Nowadays, online-scores and ratings, have become a significant factor, that have heavy influence on consumer behaviour and the success of any business (or, enterprise, product, service, etc.). Businesses across various industries, such as, but not limited to, hospitality, e-commerce, manufacturing, production, services, real-estate, retail, brands, etc., that heavily rely upon a positive online-score, hence they yearn for the highest ratings and maximum positive reviews, in order to keep attracting new customers, as well as, to retain the old customers, due to their established good-will in the public. These good/positive reviews, in-turn generates higher profits from their specific revenue-streams. However, a negative/poor review on the other hand, can deter potential new customers and lead to financial losses. Thus negative/poor review, in some cases, even initiates a snowball-effect that keeps on propagating on a downward-spiral, until the entire good-will of the business is completely lost, due to negligence and/or indifference to the consumer needs/emotions/trends, as available within the feedback of the online-scores.

Traditional methods for analysing online-scores of a revenue-stream, often involves manually reading/reviewing and involves a tedious categorization process, which tends to be time-consuming, labour-intensive, and prone to human-errors or human-biases. Further in today's scenario, the sheer amount of data, that needs to be processed is extremely high in volume, as the magnitude of online-scores generated are increasing day-by-day, within any domain, to such an extent that, now it is near-impossible to objectively analyse this data with the help of humans-alone. Moreover, these past methods typically focus, purely on sentiment/textual analysis, providing a general overview of positive or negative feedback, without identifying any specific areas/attributes/issues/issue-categories, to be improved within the said revenue-stream.

Existing solutions within the market primarily offer, basic sentiment-analysis or, keyword-based categorization, of the online-scores pertaining to a revenue-stream. These solutions generally lack the capability, to be able to provide actionable recommendations. Further, more specifically, these methods/systems do not predict/estimate the potential-impact such as, future-loss, cost of the amendment, etc., of these online-scores with respect to each of the revenue-stream. The objective and analytical approach, is completely lacking in existing solutions, such as, specifically identification of a plurality of distinct issue-categories with respect to each of the revenue-streams. As well as, they do not provide any kind of an estimate, for future-losses incurred within any of the revenue-stream, in the event that the proposed recommendations are not carried out. Importantly, none of the current solutions provide such recommendations, for a multitude of user desired revenue-streams at once, so that the recommendations and other related outputs, may be compared against each of the revenue-stream. Further, the past solutions do not allow any way to categorize or prioritize these generated recommendations. Furthermore, most importantly the previous solutions have no provision, for booking an appointment with a technical/product/service expert, in order to, mitigate any of the issues identified within the issue-categories, or, implement the generated recommendations. Moreover, these past solutions lack, a provision for adding a new user-defined issue-category, that must be included mandatorily, within the obtained/analysed online-scores, as well as, the effect of these online-scores with respect to each of the desired revenue-streams. Additionally, the past solutions, do not provide any way of analysing the importance of one single online-score, that has garnered a significantly high number of likes, comments and/or enjoys an exalted status within the public opinion, based on its unique impact on the revenue-stream. More importantly, all past solutions lack any kind of categorization/assignment, of these various identified issue-categories with respect to the each of the revenue-streams, so that the user may compare, analyse, review, contemplate, etc., with respect to each issue-category, each issue-category's super-category, as well as, the revenue-stream, with respect to, a variety of parameters. Lastly, these previous solutions completely fail to provide, an estimated expenditure incurred, with respect to each of the proposed recommendations, with respect to, mitigating each of the issue-categories of each of the desired revenue-streams. While, it should be noted that, these past solutions lack the ability to disclose all the information provided above, in an intelligible sentence-form, that is easily digestible by the user. Lastly, all previous solutions absolutely fail to disclose an ability to enable a user to book an inspection/appointment with an industry-expert for conducting a more detailed inspection/estimation, of the respective issue-category with respect to any of the desired revenue-streams.

Ultimately, existing solutions in the market are limited in terms of their accuracy, ease of use, and real-time capabilities. There is a need for a system that integrates advanced analysis methods and systems in a user-friendly manner, to provide accurate insights with respect to, a revenue-stream based on, the online-scores of that revenue-stream.

The purpose of the present subject matter presented below, is particularly to provide a simple, economic, swift and efficient solution to the all the above described drawbacks and short-comings within the art, in order to, at least partially overcome most of the above-mentioned disadvantages.

### SUMMARY OF THE INVENTION

The present subject matter broadly pertains to the field of data analysis, specifically to methods and systems, for determining the impact of online-scores, on one or more revenue-streams of interest, by further generating actionable recommendations for improving various aspects of each of these desired revenue-streams. Further, estimating future-loss incurred by the revenue-stream, in case the generated recommendations are not carried out. Furthermore, in some embodiments of the present subject matter, the object of the present method and system is to primarily assist a user, in estimation/identification of specific damage-areas (issue-categories) and the related future revenue loss, as well as, in generating recommendations, possible fixes, solutions, etc., along with the projected profit/loss attributes, with respect to each of the issue-categories of the selected revenue-streams.

Further, the subject matter elaborates regarding, estimation of potential financial repercussions of inaction, or in other words, the failure to follow the generated recommendations. This estimation of potential financial repercussions, is presented to the user, as a future-loss within the said revenue-stream, with respect to each of an identified issue-category, in an objectively comprehensive and user-friendly manner. Furthermore, in some embodiments of the present subject matter, the estimation of potential financial repercussions of each revenue-stream may also be cumulatively provided (including all the identified issue-categories) to the user, if so desired.

Furthermore, the present subject matter provides a computer-implemented method and system, for determining the impact of online-scores on revenue-streams and further is responsible for generating actionable recommendations. The method and system, as presented here, in some embodiments includes, receiving input from a user regarding one or more revenue-streams, processing a plurality of online-scores (reviews, ratings and/or other user-feedback) with respect to each of the revenue-streams, by conducting a textual analysis process followed by a categorization process, by measuring the frequency of non-positive aspects of online-scores, that fall within each of an identified issue-category, with respect to, each of the desired revenue-streams. Then, generating possible recommendations based on these analysis results, in order to present an estimation of the future-loss incurred, with respect to each of the revenue-streams, in case the generated possible recommendations, are not carried out within a defined due time. Lastly, presenting the entirety of these analysis results and the possible recommendations to the user.

Primarily the present subject matter offers a novel and effective solution for various businesses, owners, manufacturers, retailers, hospitality industry workers, freelancers, creators, professionals, etc., in order to proactively manage the online reputation of any desired revenue-stream/s, identify areas for improvement, and optimize their revenue-streams based on actual data-driven insights, obtained by implementing the method and system, as provided within the present subject matter.

Secondarily the present subject matter offers a novel and effective solution for various buyers, renters, leasers, purchasers, market/product analysts, etc., in order to proactively investigate the online reputation of any desired prospective revenue-stream, and, identify areas for improvements and/or optimizations that the revenue-stream necessitates based on actual data-driven insights, obtained by implementing the method and system, as provided within the present subject matter. Further, in some embodiments of the present subject matter, a budding entrepreneur, or any journalist, may also utilise this system and method to investigate the plethora of characteristics and other nitty-gritties, with respect to a desired revenue-stream, as provided above, in order to conduct a prospective/factual analysis of that revenue-stream and its operational issues, costs, feedbacks, etc.

The computer-implemented method and system, conducts a textual-analysis of all the obtained online-scores, this step has two distinct phases, first a collection phase acquires the plurality of online-scores, with respect to each of the said revenue-streams. This is then followed, by a textual-analysis phase, that de-duplicates, sanitizes and normalizes, all the obtained online-scores, with respect to each of the revenue stream/s.

Further, the computer-implemented method and system, comprises an internal proprietary logic, that measures the non-positive aspect of each of these online-scores, in order to identify a plurality of issue-categories, with respect to, each of the desired revenue-stream/s. This is achieved by the internal proprietary logic, by mainly computing certain values over a pre-defined time-period, wherein these certain values are such as, but not limited to, a frequency of online-scores, a frequency of non-positive aspects of the online-scores, percentage of non-positive aspects of the online-scores, usage-statistics, weightage-parameter, etc.

The internal proprietary logic, after analysing the non-positive aspects of the online-scores, with respect to each of the revenue-streams, yields a plurality of specific indicators. These specific indicators that are yielded is/are, but not limited to, increase in sales, decrease in sales, increase in customer satisfaction, decrease in customer satisfaction, customer-retention, etc.

Moreover, the internal proprietary logic utilises the measured non-positive online-scores and the yielded plurality of specific indicators, with respect to each of the said revenue-streams, in order to identify a plurality of issue-categories, with respect to each of the said revenue-streams.

In certain embodiments, of the present subject matter, the method and system include, a step of assigning the identified plurality of issue-categories, into a plurality of super-categories by the internal proprietary logic, based on one or more predefined criterion, that orders these issue-categories into some logical/analytical/prioritized order. This pre-defined criterion is/are selected, to be any one from among the following, as per the user's desire:
a return-on-investment
a budget-limited
a time-bound
a comparative-analysis
a potential-revenue-lost
a level-of-urgency
a level-of-expectedness.

Further, the plurality of super-categories based on the level-of-urgency criterion, include the following super-categories:
a suggestion
a deficiency
a rectification
an immediate-action.

Furthermore, the plurality of super-categories based on the level-of-expectedness criterion, includes the following super-categories:
a typical issue-category
a non-typical issue-category.

In certain embodiments, of the present subject matter, it includes a step of generating a plurality of recommendations, with respect to each of the identified issue-categories, of each of the said revenue-streams, wherein the process also includes generating, an accurate expenditure for conducting an amendment, with respect to each of the identified issue-category, with respect to, each of the said revenue-streams.

The generated accurate expenditure, contains at least one of the following information:
a project-plan
a time-estimate
a cost-estimate.

In certain embodiments, of the present subject matter, the system and method include, a step of booking of an intensive-technical-review, for gaining a detailed recommendation, for all the user desired issue-categories, with respect to any of the desired revenue-streams.

In certain embodiments, of the present subject matter, the system and method include, a step of presenting as output, all the analysed, identified, generated, assigned and booking data/information, with respect to each, of the said revenue-streams, in an intelligible sentence-form to the user.

In certain embodiments, of the present subject matter, includes a step of defining one or more specific issue-categories of interest to the user, during the input process, with respect to each of the desired revenue-streams.

The subject matter boasts versatile applicability, across a spectrum of user-oriented domains, including but not limited to, real estate, restaurants, shopping malls, appliance stores, and other sectors where online-scores significantly influence the revenue generation. More significantly, the method may be employed across a variety of industries, such as hospitality, e-commerce, manufacturing, production, services, real-estate, retail, brands, etc.

For example, in the context where the revenue-stream is a real-estate unit, the subject matter could help the user, in analysing all the reviews mentioning issues, such as but not limited to, cleanliness, damage, or amenities, with respect to, a building/apartment, and then goes on to recommend specific repairs/improvements/fixes to address these identified issues, by visually presenting this information in a user-friendly manner, as an output for the user. Further, the method disclosed in the present subject matter, also estimates the potential future-loss in rental-income or saleable-price of this real-estate property, if these proposed recommendations are not implemented, within a prescribed time-period.

Similarly, in another context where the revenue-stream is a saleable product, the subject matter could analyse reviews mentioning, issues such as usage difficulties, product defects, or missing features, based on which it may then recommend specific product improvements or alternative product features to the user. Further, the method disclosed in the present subject matter, also estimates the potential future-loss incurred in the sale of the said product, in case these proposed recommendations are not implemented, within a prescribed time-period.

Certain significant features of the present methods and systems, are provided below:
Identifying specific issue-categories that are frequently associated with non-positive aspects of the online-scores.
Calculating the frequency of non-positive aspects of the online-scores, with respect to each issue-category, in order to prioritize improvement areas of the revenue-stream, over a time-period.
Generating actionable recommendations for amendments or improvements to the revenue-stream, based on the identified issue-categories, that have the most impact on the non-positive aspects of the online-score.
Estimating the expected potential future-loss from the revenue-stream, if the proposed recommendation of amendments/fixes are not implemented. Further, this estimated future-loss is provided as a cumulative amount for the whole of each revenue-stream, or, a plurality of individual amounts, with respect to each of the plurality of issue-categories, with respect to each revenue-stream separately.
Presenting all the analysis results and proposed recommendations in a user-friendly format, enabling businesses, owners, freelancers, manufacturers, etc. to make informed decisions, for optimizing their revenue-streams.
Prioritization of resources/funds, as the user makes a well-informed decision regarding which of the identified issue-categories, to address first, based on a plethora of criterions.
Allows for comparison of various issue-categories, recommendations and estimated future-losses, amongst a plurality of desired revenue-stream/s.
Provides all the information to the user, in an intelligible sentence form and further even allows artificial conversation, with all the identified, generated, estimated, booking and assignment data/information.

For purposes of summarizing the invention and the advantages achieved over the prior art, certain objects and advantages of the invention have been described above. Of course, it is to be understood that, not necessarily all such objects or advantages may be achieved in accordance with any one particular embodiment of the invention. Thus, for example, those skilled in the art will recognize that, each embodiment of the invention, may be embodied or carried out, in a manner that achieves or optimizes, one advantage or a group of advantages.

Various sub-methods and/or additional processes, are claimed in the independent/dependent claims, these embodiments may be, combined, or, applied separately, with respect to each other. To the accomplishment of the foregoing and related ends, certain illustrative aspects of the disclosed innovation are described herein, in connection with the following description and the annexed drawings. These aspects are indicative however, of but a few of the various ways in that, the principles disclosed herein may be employed and are intended to include all such aspects and their equivalents. Other advantages/applications and novel/inventive features will become apparent from the following detailed description when considered in conjunction with the drawings/illustrations provided.

### BRIEF DESCRIPTION OF THE DRAWINGS

The summary above, as well as the following detailed description of illustrative embodiments, is better understood when read in conjunction with the appended drawings/figures. For the purpose of illustrating the present subject matter, exemplary illustrations of the subject matter are depicted within these drawings. However, the present subject matter is not limited to specific methods and instrumentalities disclosed herein.

Moreover, those in the art will understand that the drawings are not to scale and are also not inclusive of all essential components/elements.

Embodiments of the present subject matter will now be described, by way of example only, with reference to the following Drawings/figures, wherein:

FIG. 1 depicts a schematic view of a method/system 100, for obtaining a first and a second output.

FIG. 2 depicts a schematic view of a method/system 200, for obtaining a third output.

FIG. 3 depicts a schematic view of a method/system 300, for obtaining a fourth output.

FIG. 4 depicts a schematic block-diagram, of a method/system for determining the impact of online-scores on one or more revenue-stream/s 400.

In the accompanying drawings, an underlined number is employed to represent an item over that the underlined number is positioned, or, an item to that the underlined number is adjacent. In other words, an underlined number depicts the whole method/system and is a reference to that embodiment of the method/system, in the specific figure, that it is illustrated/mentioned in. Whereas, a non-underlined number relates to an item identified by a line linking the non-underlined number to the item. When a number is non-underlined and accompanied by an associated arrow, the non-underlined number is used to identify a general item, at that the arrow is pointing to.

### DETAILED DESCRIPTION

The features and advantages of the present subject matter, just as they are stated in the claims, will now be described in detail with reference to the appended drawings, showing several examples of deployment configurations/embodiments for the present invention.

Furthermore, the present subject matter provides a computer-implemented method and system, for determining the impact of online-scores on revenue-streams and further assists by generating actionable recommendations to improve said online-scores. The method and system, as presented here, in some embodiments, includes receiving input from a user regarding one or more revenue-streams, processing a plurality of online-scores (all available, reviews, ratings and user-feedback), with respect to each of the revenue-streams, by utilising textual analysis followed by, categorization step that measures the frequency of non-positive aspects of online-scores, within each of an identified issue-category, of each of the revenue-stream. Then, generating the possible recommendations based on these analysis results, in order to eventually present, an estimation of the future-loss with respect to each of the revenue-streams, in case the possible recommendations are not carried out. Lastly, presenting the entirety of these analysis results and the possible recommendations to the user.

The computer-implemented method and system, in an embodiment of the present subject matter, includes first receiving input from a user regarding one or more revenue-streams, then obtaining a plurality of online-scores (reviews, ratings, comments, user-feedback, news, etc.), with respect to each of the revenue-streams, from various online sources. This step of obtaining online-scores has two distinct phases, first a collection phase that acquires the plurality of online-scores, with respect to each of the said revenue-streams. This is then followed by a textual-analysis phase, that sanitizes all the obtained online-scores, in order to, de-duplicate, sanitize and normalize the obtained data, with respect to each of the revenue stream/s.

Further, the computer-implemented method and system, comprises an internal proprietary logic, that analyses various parameters of the identified, de-duplicated, sanitized and normalized data that is obtained. This process of analysis that is conducted by the internal proprietary logic, measures the non-positive aspect of each of these online-scores, in order to identify the plurality of issue-categories, with respect to, each of the desired revenue-stream/s. This is achieved by the internal proprietary logic, by mainly computing certain values over a pre-defined time-period, wherein these certain values are such as, but not limited to, a frequency of online-scores, a frequency of non-positive aspects of the online-scores, percentage of non-positive aspects of the online-scores, usage-statistics, weightage-parameter, etc., within the obtained data.

The internal proprietary logic then, after analysing the non-positive aspects of the online-scores with respect to each of the revenue-streams, yields a plurality of specific indicators. These specific indicators that are yielded is/are, but not limited to, increase in sales, decrease in sales, increase in customer satisfaction, decrease in customer satisfaction, customer-retention, etc. These specific indicators, also allow the user to analytically and objectively, account for the correlation between the real-world statistics and the plurality of obtained online-scores.

Moreover, the internal proprietary logic, utilises the measured non-positive online-scores and the yielded plurality of specific indicators, with respect to each of the said revenue-streams, in order to identify a plurality of issue-categories, with respect to each of the said revenue-streams. These issue-categories are in simple terms the various issues that plague the particular revenue-stream, which are identified as the main proponents, of most of the negative-aspects of the plurality of online-scores with respect to that revenue-stream. For e.g. if the revenue-stream is a restaurant, then some of the issue-categories could be, but not limited to, less cheese in pizza, burger patty not well-cooked, fries are too oily, beverages served are never cold enough, waiters lack knowledge, parking not easily available, etc. In another example, if the revenue-stream is a real-state unit, then some of the issue-categories could be, but not limited to, roof-leaks when it rains, swimming pool is not heated, balcony railing rusted, gas-line not operational, floor creaks in certain areas, outer wall needs a fresh coat of paint, etc.

In certain embodiments, of the present subject matter, the method and system include, a step of assigning the identified plurality of issue-categories, into a plurality of super-categories by the internal proprietary logic, based on one or more predefined criterion, that orders these issue-categories into some kind of logical, analytical and/or prioritized order. This pre-defined criterion is selected to be any one, from among the following, as per the user's desire:
a return-on-investment
a budget-limited
a time-bound
a comparative-analysis
a potential-revenue-lost
a level-of-urgency
a level-of-expectedness.

Further, the plurality of super-categories based on the level-of-urgency criterion, includes the following super-categories:
a suggestion
a deficiency
a rectification
an immediate-action.

Furthermore, the plurality of super-categories based on the level-of-expectedness criterion, includes the following super-categories:
a typical issue-category
a non-typical issue-category.

In certain embodiments, of the present subject matter, includes a step of generating a plurality of recommendations, with respect to each of the identified issue-categories, of each of the said revenue-streams, wherein the process also includes generating, an accurate expenditure for conducting an amendment, with respect to each of the identified issue-category of each of the said revenue-streams.

The generated accurate expenditure, contains at least one of the following information:
a project-plan (or, a road-map)
a skill-estimate
a time-estimate
a cost-estimate.

In certain embodiments, of the present subject matter, includes a step of booking of an intensive-technical-review, for gaining a detailed recommendation, for all the user desired issue-categories.

In certain embodiments, of the present subject matter, includes a step of presenting as output, all the analysed, generated, assigned, recommended, estimated and/or booking information/data, with respect to each of the said revenue-stream/s, in an intelligible sentence-form to the user. Further, in some embodiments, allowing the user to chat with the internal proprietary logic, in order to provide more detailed information, with respect to any desired aspect of the information, or, alter their inputs/parameters of analysis to generate new information, if so desired.

In certain embodiments of the present subject matter, the method and system, includes a step of defining one or more specific issue-categories of interest to the user, during the input process, with respect to each of the said revenue-streams.

The subject matter boasts versatile applicability, across a spectrum of user-oriented domains, including but not limited to, real estate, restaurants, shopping malls, appliance stores, brands, manufacturers, freelancers, teams, and/or basically an entity belonging to any sector, where the online-scores within that sector significantly influence the revenue generation ability of the said entity. More significantly, the method may be employed across a variety of industries, such as hospitality, multi-family, conglomerates, associations, financial institutions, political parties, e-commerce, manufacturing, production divisions, services, real-estate, retail, brands, or, to any entity that has been rated, reviewed or been given an online-score, by any of the past patrons/users of a product/service provided by that entity. Alternatively, the method and system may also be utilised, to improve internal team efficiencies and revenue-generation based analysis, within corporate environments, where a large number of people, businesses, operations, etc. are employed under the common banner of, for example a conglomerate, business venture, etc.

For example, in the context of, a real-estate building being the revenue-stream, the system and method presented in this subject matter, could help the user analyse all the reviews mentioning issues, such as but not limited to, cleanliness, damage, or amenities with respect to, a building/apartment, and then, goes on to recommend specific repairs/improvements/fixes, to address these identified issues, by visually presenting this information in a user-friendly manner, as an output for the user. Further, the method disclosed in the present subject matter, also estimates the potential future-loss, in rental-income, or, saleable-price, of the real-estate property, in the event that, these generated proposed recommendations are not implemented, within a prescribed amount of time.

Similarly, in the context of, a hotel/resort being the revenue-stream, the system and method presented in this subject matter, could help the user analyse all the reviews mentioning issues, such as but not limited to, lack of hot water, air-condition malfunctions, no sea-view rooms, pest infestation, mouldy carpets, etc. with respect to, the hotel/resort, and then, goes on to recommend specific repairs/improvements/fixes, to address these identified issues, by visually presenting this information in a user-friendly manner, as an output for the user. Further, the method disclosed in the present subject matter, also estimates the potential future-losses in the per night cost of the hotel/resort. As, it is well known that, the exact bracket of star-rating awarded to a hotel/resort, has a direct influence on the per night cost of rooms, huts, villas, etc. (excepting of course, tourist-season, special events, conferences, concerts, etc.), that is primarily caused due to these continued poor/negative reviews as described above. Hence, if some, most, or preferably all, of these issues are not resolved immediately, based on the generated proposed recommendations, within a prescribed amount of time, with respect to each of these identified issue-categories, the hotel/resort shall continue to face losses. This scenario must be essentially avoided at all costs, as this then holds the hotel/resort back, from having enough resources leaving them handicapped, in terms of being able to, improve/maintain the facilities, or, fuel any kind of future expansion plans. The method and system of the present subject matter, allows the user to specifically pick and choose, each of the issues/issue-categories to be resolved, by prioritizing the identified issue-categories into, for example, highest impact on the star-rating issues to be on the top of the list/assignment, while the issue-categories that have the lowest impact on the star-rating of the hotel/resort at the bottom of the list, while also sorting all the identified issue-categories to conform to their assignment, as per their impact-level on the star-rating of the resort/hotel. This enables the user to, address the highest impact-level issue-categories first, which in-turn will have the maximum positive impact on the star-rating of the hotel/resort, allowing for them to increase the per night cost compared to the past, allowing them to build-up resources continuously, if the user follows-through on the prioritized recommendations list, to enable the hotel/resort flourish and expand in the future.

Alternately, in the context of, an online-product being the revenue-stream, the system and method presented in this subject matter, could analyse all the reviews mentioning, issues such as, but not limited to, product-usage difficulties, product defects, missing features in the product, colour not same as advertised, etc., based on this it may then recommend specific product improvements or alternative product features to the user. Further, the method disclosed in the present subject matter, also estimates the potential future-loss incurred in the sales of the said product, in case these proposed recommendations are not implemented, within a prescribed time-period.

Similarly, in yet another context of, an appliance being the revenue-stream, the system and method presented in this subject matter, could analyse reviews mentioning, issues such as, but not limited to, appliance-manual understanding difficulties, appliance using too much power, appliance not upto quality standards, any component defects, missing features in the appliance, doesn't perform as advertised, etc., based on this it may then recommend, specific appliance designs, specifications, additions, omissions, improvements or other alternative product features to the user. Further, the method disclosed in the present subject matter, also estimates the potential future-loss incurred in the sales of the said appliance, in case these proposed recommendations are not implemented, within a prescribed time-period.

### Definitions of Terms Used

In the case, where there are two or more definitions of a term that is used and/or accepted within the known art, the definition of the term as used herein, is intended to include all such meanings unless explicitly stated to the contrary.

For purposes of the detailed description of the preferred embodiments, the definitions of most of the essential terms, that are utilised and enforced, throughout the present subject matter including the claims, are provided as follows:

The term “user” refers to, anyone having an interest in analysing, the impact of online-scores with respect to any revenue-stream. Further, it is understood that the user has access to the method and system of analysis, presented within the present subject matter, via the use of a user-device with internet connection. Further, the user is for example anyone, such as but not limited to a/an, buyer, renter, guest, patron (of products/services), owner, producer, manufacturer, designer, inventor, distributor, sales agent/executive, marketer, promoter, operator, builder, architect, decorator, engineer, doctor, lawyer, electrician, plumber, driver, researcher, analyst, student, investigator, or, the like such as any homo-sapien/human with an interest in analysing/reviewing, one or more revenue-streams primarily based on their online-scores.

The term “revenue-stream” refers to, any type of product, property, lease or service that possesses some form of online-score data, on any/all of the various online-score platforms that are available online publicly, or, any kind of private/non-public feedback/online-scores provided/made-available by a user as input. Revenue-stream includes, but is not limited to any, product, design, art, property (physical or intellectual), cab/taxi services, delivery services (food, medication, groceries, flowers, etc.), e-commerce, pharmaceutical drug, edible items, compute/smart application, software, hardware, online services, freelance services, web-stores, technical equipment, furniture, appliances, house, house-hold items, building, villa, apartment, mansion, chalet, restaurant, resort, industrial plant, workshop, shop, cubicle, office-space, venue, theme-parks, halls, fields, other constructions/infrastructures, any human-dwelling, or the like, as is known within the art.

The term “online-scores” refers to, the entirety of data generated by all the previous users/patrons, that has been documented online, primarily providing an account for their experience, with respect to each of the desired revenue-streams. These online-scores, as is known within the art, are captured via various modes and to a highly variable degree of detail depending on the precise revenue-stream, including, but not limited to, any kind of ratings, rankings, star-ratings, reviews, comments, check-box style feedback, critique reviews, internal reviews, feedback calls/forms, silent reviews, customer/user feedback, news/review articles, newspapers, magazines, social-media reviews, mentions, memes, GIFs, other similar data that is generated by past users/patrons of that specific revenue-stream, available to the method and system of the present subject matter on the various known online and offline sources. However, it must be noted that, the online-score data may also be accrued from the user as an input, in case the online-score/feedback data, is privately collected data of the user.

The term “sources” or “various sources” refer to a plurality of data-sources, that are known or otherwise, from where the online-scores with respect to the desired revenue-streams is/are obtained. These data-sources may comprise, various public/non-public data-sources, such as but not limited to, websites, applications, online-scores, internal reviews, capex, stock-market, business trackers, building owners, general ledgers, capital plans, budgets, service order records/requests, feedback-forms, feedback-databases, comments, sub-comments, memes, GIFs, reviews, mentions, news and any of the combinations thereof. The non-public sources may further include, but not limited to, specifically conducted feedback calls, chatbot-data (such as, feedbacks, reviews, interactions, etc.), silent reviews, interviews, or, actual-observations of some of the revenue-stream, in real-time available for some instances. In an embodiment of the present subject matter, the non-public data in some instance is provided by the user, during initial input depending on such need/requirement for the desired revenue-stream, as per user's desire. This non-public data may be uploaded by the user during input, in any electronic-form, such as, text, image, digital documents, etc.

The term “non-positive aspect of each of the online-scores” or simply “non-positive aspect” is referring to any and all, kind of negative/non-satisfactory information/data, within the obtained online-scores, regardless of the depth of details that are available, with respect to the each of the desired revenue-stream. This non-positive aspect of each of the online-scores, with respect to the revenue-stream comprises of, but not limited to, all the past/previous bad ratings, poor ratings, textual feedback/review containing complete or partial non-positive experience, negative/weakness verdicts (such as, available on comparison reviews/websites), negative memes/reels/shorts/status, any kind of depreciative market influence (all types of negative news, magazine articles, excerpts, false-advertisements, myths, word-of-mouth), and any other similar negative inference, with respect to the desired revenue-stream, that may in the future influence a potential buyer, user, leaser, renter, patron, etc., by deterring them from availing/using the said revenue-stream. Please note, the method and system of the present subject matter intends to detect and analyse, each such instance, where any kind of non-positive aspect, with respect to, each specific revenue-stream has been recorded, by a previous patron/user of the specific revenue stream.

The term “measure of non-positive aspect of each of the online-scores” is referring to the computed results of any and all, kind of negative/non-satisfactory information/data, within the obtained online-scores, regardless of the depth of details that are available, with respect to each of the desired revenue-stream/s. This measure of non-positive aspect of each of the online-scores, with respect to the revenue-stream, comprises of but not limited to, analysing various statistics/characteristics of the online-scores, compared to a predefined time-period and/or location, such as, frequency of online-scores with similar/same issues mentioned within them, total number/frequency of online-scores with respect to the revenue-stream, number/frequency of each type of non-positive aspects or issue-category, percentage of non-positive aspects with respect to the entirety of online-scores, etc. regarding each of the revenue-stream/s, and other similar attributes as are known, within the art.

The term “issue-category” or “issue-categories” refers to specific categories or sub-categories of issues, with respect to each of the desired revenue-stream/s. The issue-categories, for example comprises, but is not limited to these generic categories/sub-categories of, tardy services, lack-of skill/knowledge/ability, cheap-material, difficulty-in enjoying the product/service/property, over-priced product/service/property, etc., with respect to each of the revenue-streams, regardless of whether the revenue-stream is a product, service or, a property for sale/lease, etc. For example, in case the revenue-stream is a mobile application, then in that case the method and system of the present subject matter, may comprise issue-categories, such as but not limited to, slow interface, glitchy controls, delayed response, less/fake users (specifically, in case of a social media application), too many advertisements, overpriced premium tiers, no cloud backup, and other similar issues, as known within the domain. Further, for example, in case the revenue-stream is a real-estate unit, then in that case, the method and system of the present subject matter, may comprise issue-categories, such as but not limited to, roofing (flaking, cracking, leaks, dangers, awnings, etc.), walls (damages, discoloration, repairs, loss of integrity, etc.), structures such as, pillars, beams, walls, girders, guardrails, bracing, anchoring components (deterioration, rusting, aging, bending, chipping, hazards, loss of integrity, etc.), plumbing (leakage, water leak in utility closet, plumbing fixture leaks, sewer smell, water leaks behind sheetrock, leaking water heaters, toilet not flushing, fixtures that are in poor condition, no hot water, low or no water pressure, etc.), piping (sanitary not draining, below ground sanitary, etc.), air-conditioning (humidity/mold, heating not working, ac not working properly, thermostat issues, smell in HVAC, miscellaneous HVAC, fan issues, HVAC drip or leak, unbalanced HVAC, inadequate HVAC capacity, humidity troubles, etc.), electrical/fire related, window/glass related (window leak, windows fogged, window condensation, cracked/shattered/missing panes, etc.), appliances (washer/dryer issues, dishwasher issues, microwave/oven, refrigerator, etc.), any non-functioning amenity, any other potential hazard, any missing feature/facility, or, any other similar real-estate issues, and, several other known issues within the domain. Furthermore, for example, in case the revenue-stream is any kind of services, such as performed by a/an, freelancer, welder, electrician, plumber, lawyer, doctor, engineer, researcher, teacher, programmer, professor, chef, pharmacist, janitor, gardener, driver, delivery man, maid, babysitter, butler, dishwasher, etc., then in that case the method and system of the present subject matter, may comprise issue-categories, such as but not limited to, non-punctual, slow worker/s, low-quality work, delayed/underwhelming response, unprofessional behaviour/workmanship, chatty, silent, over-payed, un-imaginative, accident prone, any damages caused during service deployment, and several other known similar issues within the domain. Moreover, for example in case the revenue-stream is a hospitality industry such as a restaurant, hotel, motel, resort, adventure park, etc., then in that case the method and system of the present subject matter, may comprise issue-categories, such as but not limited to, slow service, wrong order, delayed delivery, poor quality of ingredients, stale food, limited menu, unhygienic, cramped/unattractive ambience, overpriced items/services, lack of Wi-Fi/maintenance/clean-water and several other known similar issues within the domain. Lastly, the issue-categories within any embodiment of the present subject, may be assigned to a super-category for providing various analytical, objective, comparative and subjective overviews to the user with respect to each of the revenue-streams, as well as, in-between a plurality of desired revenue-streams, as per the user's preferences.

The term “recommendations” is referring to the specific recommended actions, that are generated, by the method and system of the present subject matter, with respect to each of the identified issue-categories, of each of the user desired (user input) revenue-streams. In essence, each of the plurality of issue-categories for each of the user desired revenue-stream are first identified after analysis of the online-scores, and then an appropriate recommendation is generated, in order to mitigate, each of these identified issue-categories that are identified with respect to, each of the revenue-streams. The recommendations, for example comprises, but is not limited to, generic solutions/fixes that mitigate and overcome, the core-ailments underlying the various identified issue-categories, such as, training workers/employees, upgrading skill/knowledge/ability, using better materials, simplifying the product/service/property experience from the point-of-view of the user/patron, reducing revenue losses/wastage, in order to, decrease costs of product/service/property, etc., with respect to each of the revenue-streams, regardless of whether the revenue-stream is a product, service or, a property for sale/lease, etc. Here, it must be noted that, the recommendations provided by the method and system of the present subject matter, is/are highly dependent on the specific revenue-stream, as well as, the particular problems/issue-categories, that undermine the said specific revenue-stream, in each such case. Hence, pre-defining all possible issue-categories and/or recommendations is near impossible, however, the method and system is more than capable of conducting analysis of the issue-categories and generating pertinent recommendations, with respect to any type of revenue-stream almost instantaneously in real-time. Specifically, it must be noted that, these recommendations, for each of the issue-categories, of each of the user input revenue stream/s, form a first output for the user.

The term “future-loss” refers to the process of estimating the potential losses incurred in the future by each of the revenue-stream/s, in case the plurality of generated recommendations with respect to, each of the identified issue-categories, are disregarded, or, in other words not implemented. This prediction/forecast of projected losses in future, utilises all the obtained, analysed, measured, identified, generated details/information, in order for estimating, a meticulously detailed account of the future prospects, including but not limited to, inclusion of additional information such as, foreseeable issues, industry/competition solutions affecting the desired revenue-stream, direct/indirect attributes that will/may arise in due course of time. Primarily the future-loss, refers to a potential revenue-loss, due to disregard of the maintenance, repairs, upgrades, fixes, training, etc., that are generated as possible recommendations, with respect to each of the issues/issue-categories, of each of the desired revenue-stream/s. This ensures that the user is appropriately alerted/notified regarding each of the desired revenue-stream/s, including but not limited to, all the pertinent information (costs, time-periods, complexity-levels, etc.) about all such possible repair/maintenance/fixing events in real-time, with maximum precision and accuracy. This enables a user to make a well-informed decision, regarding each of the issues/issue-categories of each of the revenue stream/s, based on hard-evidence and analysis of the available online-scores. Further, the term “disregarded” refers to the in-action or omission, by a user with respect to the possible recommendations that are generated, in order to mitigate the various issue-categories that are identified, with respect to each of the desired revenue-stream/s.

The term “output” or “outputs” is referring to specific kind of data/information, that is presented to the user, accessing the method and system of the present subject matter. The user is presented several aspects of information, at each step of implementation of the method and system described herein, with respect to one or more revenue-stream/s of choice/desire. Specifically, theses aspects that are presented as output, to the user in real-time include, but are not limited to, plurality of issue-categories with respect to each of the revenue-stream/s, recommendations with respect to each of the identified issue-categories, future-loss estimate with respect to each recommendation that is disregarded, cumulative amount of recommendations and/or future-loss with respect to the whole of each revenue-stream, plurality of individual amounts with respect to each of the plurality of issue-categories of each of the desired revenue-stream/s, an intelligible sentence-form of information (analysed, measured, identified, generated, estimated, assignment and booking information/data) compilation, with respect to each of the said revenue-stream/s, and other similar aspects as is known, within the art.

The term “collection phase” is referring to the process of acquiring the plurality of online-scores, with respect to each of the user-desired revenue-streams. This phase includes, the process of acquiring vast amounts of external data, with respect to each of the revenue-streams of interest, from the various sources, that are available to the method and system of the present subject matter, at the time of execution. All the possible types of online-scores are acquired during this phase, for further processing.

The term “textual-analysis phase” is referring to the process of identification, de-duplication, sanitization and normalization of textual-discrepancies within the obtained/acquired online-scores, of each of the revenue-stream/s of interest, using programmes/algorithms based on Natural Language Models. The textual-discrepancies includes, but are not limited to, spelling-mistakes, abbreviations, word-truncations, mis-spelled words, and other known discrepancies of similar nature. Further, the information from the various sources may be incomplete, due to space constraints or other reasons, where many of the words, or, sometimes entire sentences may be missing/omitted, in such cases, context-based algorithms/programmes are utilised. Hence, the textual-analysis phase identifies, de-duplicates, sanitizes and normalizes all such textual discrepancies and incomplete instances, within the obtained online-scores from the various sources, to provide a clean-set of online-scores to an internal proprietary logic for further processing. This phase in some embodiments, analyses and characterises the various online-score data such as, rating-values, text, check-points, images, videos, sentiments, etc., so the varying type of content they provide is made available in a useable-form for deeper analysis, with respect to each of the desired revenue-stream/s. Further, it should be noted that, the textual-analysis phase, in any of the embodiments of the present subject matter, discards all the captured non-relevant data/information, so that only relevant data/information with respect to each of the desired revenue-stream/s is captured, sanitized and normalised for analysis by the internal proprietary logic. Moreover, in any of the embodiments of the present subject matter, the textual-analysis phase, includes a sub-routine of sentiment-analysis, that ensures that any type of human-expressions within the various types of online-scores, are not misinterpreted, or, left-out within the weightage parameter. Lastly, in any of the embodiments of the present subject matter, the textual-analysis phase, includes a sub-routine of sentiment-analysis, that analyses any mistakes/discrepancies, within the obtained star-ratings, or, other similar point-based ratings and the attached comments/review with those ratings, provided by a past patron/user of that revenue-stream. Essentially, this ensures that any wrongly given positive point-based ratings are not left out of the analysis process, particularly when the system and method of the present subject matter, are focused on analysing the negative-aspects of each of the desired revenue-stream/s.

The term “internal proprietary logic” refers to the processing algorithm or program, that is utilised for analysing the clean-set of online scores, with respect to each of the desired revenue-stream/s, by measuring the non-positive aspect of each of these online-scores, in order to firstly identify the plurality of issue-categories, with respect to each of the desired revenue-stream/s. The internal proprietary logic essentially, analyses the measure of non-positive aspects of the online-scores with respect to each of the revenue-streams, by computing certain values over a pre-defined time-period, wherein the certain values are for example, but not limited to, frequency of online-scores, frequency of non-positive aspects of the online-scores, percentage of non-positive aspects of the online-scores, etc, wherein the per-defined time-period may vary based on the availability of data for that particular period of time, which is then usually normalised with the help of various known statistical and probabilistic principles, as is known within the art. Further, based on these measured non-positive aspects of the online-scores, with respect to each of the revenue-stream/s are re-analysed by the internal proprietary logic, in order to yield a plurality of specific indicators. These specific indicators that are yielded by the internal proprietary logic, provide a clear indication, with respect to the profitability of each of the revenue-stream/s over a period of time, as these yielded specific indicators, are for example but not limited to, increase in sales, decrease in sales, increase in customer satisfaction, decrease in customer satisfaction, and other similar market/business indicators, as are known within the art. Specifically, it is these yielded specific indicators, that are utilised by the internal proprietary logic, in order to identify the plurality of issue-categories, with respect to each of the user-desired revenue-streams. Furthermore, the internal proprietary logic, in some embodiments of the present subject matter, categorizes the plurality of identified issue-categories, into a plurality of super-categories, based on one or more pre-defined criterion, wherein theses criterion is/are for example, but not limited to, return-on-investment, budget-limited, time-bound, comparative-analysis, potential-revenue-lost, impact-level, level-of-urgency, level-of-expectedness and other similar criterion, as is known within the art. Moreover, the internal proprietary logic also then, generates the plurality of recommendations with respect to each of the identified issue-categories of each of the desired revenue-streams, that includes, but is not limited to, an accurate expenditure for conducting an amendment, with respect to each of the identified issue-category, of each of the said revenue-streams. Importantly, it should be noted that the internal proprietary logic, forms the very core of the method and system disclosed within the present subject matter, and hence several of the processes or steps are directly/indirectly influenced by the internal proprietary logic, for providing the best possible experience to the user at every step of the entire process. Lastly, the internal proprietary logic, comprises of human-coded algorithms/programs, as well as, several other data-processing programs that are based on manual programmes/modules, large language models, deep-learning, machine-learning, artificial-intelligence, neural-networks, convolutional neural networks, reinforced machine learning, generative AI, or other similar algorithms/models, that process the obtained online-scores of each of the revenue-stream/s, to generate the various issue-categories and their respective recommendations, on a case-by-case basis for each desired revenue-stream. The internal proprietary logic is also responsible for conducting all analysis, measurements, identification, generation, estimation, assignments and re-analysis of all the information, in order to provide the user with the appropriate output in real-time. Ultimately, the internal proprietary logic assesses all output information, in order to present to the user, all essential pertinent data/information regarding the revenue-stream, in an intelligible sentence-form.

Since the “internal proprietary logic” utilises, several segregated/un-segregated programming components/modules, in the form of various programmes, models and/or algorithms, the internal proprietary logic is capable of conducting a self-assessment of the various steps of, identifying the issue-categories, generating recommendations, by reviewing these for any mistakes/errors. In case, any errors/mistakes are found during the reviewing process, a correction is made by the internal proprietary logic, in order to rectify the mistake/error, and the issue-category/recommendation is properly assigned/rectified for that issue of the revenue stream, in that instance as per the case. Further, the “internal proprietary logic” also goes on to determine the cause of this error/mistake and based on this cause, the internal proprietary logic modifies/reprograms the programs/algorithms/models that form the internal proprietary logic, in order to make sure that, the identified mistake/error is never repeated again, in future. This ensures that the internal proprietary logic, continuously increases the accuracy-level of the whole method and system. Furthermore, the internal proprietary logic conducts a re-calculation and/or re-calibration process on the entirety of data, that is at its disposal including all the online-scores of all the desired revenue-stream/s at its disposal at that time, to rectify all similar mistakes/errors within the past presented output data, of any other revenue-stream as well. Moreover, this process of re-calibration, is essential for avoiding error-duplication, wrong-categorization, inadequate-recommendation, etc. This process of self-assessment and continuous automated error-rectification of the internal proprietary logic, ensures that the accuracy of the various outputs provided by the internal proprietary logic, keeps on increasing as time passes.

The term “frequency of online-scores” or “number of online-scores” refers to a specific rate at which, the online-reviews were raised and/or published over a certain period of time, for any particular revenue-stream. This specific rate, may be identified as the total number of times the revenue-stream received an online-score, by any renter/tenant/owner/patron/user, with respect to that revenue-stream. Further, specifically in some embodiments of the present subject matter, the total frequency/number/count of online-scores relating to each issue-category, with respect to each of the desired revenue streams is measured. The term “frequency of non-positive aspects of the online-scores” or “number of non-positive aspects of the online-scores” refers to a specific rate at which, the non-positive aspects of the online-reviews, were raised and/or published over a certain period of time, for any particular revenue-stream. This specific rate, may be identified as the total number of times the revenue-stream received non-positive aspect in the online-score, by a renter/tenant/owner/patron/user with respect to that revenue-stream. Further, in any of the embodiments of the present subject matter, the phrase “non-positive aspects” specifically refers to, any and/or all types of non-positive/dissatisfaction, that is expressed with respect to each/any issue-category, of each of the desired revenue streams. For example, but not limited to, all bad-worse reviews/ratings, roasts (online/offline), mass-dislike and/or even, in the case that, the online-score is a good/excellent review, it may happen that it contains a small/minor non-positive component, addressing an issue/point-of-dissatisfaction that must be improved, as per the point-of-view of the online-score provider, so that negative-aspect is also made available to the analysis process for optimal issue-categories identification. The term “percentage of non-positive aspects of the online-scores” refers to, a comparative specific rate, in-between the non-positive aspects of the online-reviews and the total online-reviews, that were raised and/or published over a certain period of time, for any particular revenue-stream. This specific rate, may be identified as the total number of times the revenue-stream received non-positive aspect in the online-score, by a renter/tenant/owner/patron/user with respect to that revenue-stream, compared to the total frequency/rate of all online-scores, with respect to that revenue-stream. Further, in any of the embodiments of the present subject matter, the phrase “usage-statistics” specifically refers to, any usage-data that is available on the various online-sources, with respect to, each of the revenue-stream/s. This usage-data and its availability, varies significantly, based on the type of revenue-stream and the willingness of the user to provide in case if the data is private, hence, it generally comprises usage-data with respect to an available pre-defined time-period, such as, but is not limited to, number of products sold per a time-period, occupancy-rate for real-estate unit per a time-period, services rendered per a time-period, etc. Within the final output, there is an increased correlation with real-world statistics, as well as, the likelihood of accurate future simulations/calculations increases significantly, when the method and system is empowered with such past usage-data. Hence, this inclusion ensures that in such cases, the user receives more precise recommendations and estimations, with respect to each of the desired revenue-stream/s. In certain embodiments of the present subject matter, the usage-statistics, also comprises of information such as, but not limited to, stock reports, shareholder reports, news/journalist opinions, real-estate data, market/business reports, regulatory body analysis/reports, etc. that are made available, with respect to each of the revenue-stream/s, in order to include this specific additional data, to allow the method and system to be able to provide the most accurate outputs to the user. Furthermore, in any of the embodiments of the present subject matter, the phrase “weightage parameter” specifically refers to, any and/or all types of non-positive/dissatisfaction, that is expressed with respect to each/any issue-category, of each of the desired revenue streams. The weightage parameter of each of the obtained online-score is estimated by the internal proprietary logic, in order to obtain an ascending/descending order of significance. Further, the specific sentiment of each of the online-scores is analysed and documented. For understanding this concept the following example is appropriate, but the implementation definitely is not limited to just this particular instance, where assuming that just a single online-score has managed to garner a significantly high number of likes, approval, trending, comments, sub-comments, memes, GIFs, images, videos, etc., from other users, renters, patrons, buyers, owners, website-visitors, etc., then in such instances, even that single online-score holds much value, so this single online-score and all the aforementioned data is also included for acquisition, as this single online-score clearly has a relatively higher popular-streak. Hence, all the issue-categories addressing each of the pain-points described within that single online-score, are identified by the method and system of the present subject matter, despite the low frequency/count/occurrence comparatively. This ensures, that all the critical online-scores are included into the analysis process, before measuring the non-positive aspects of those online-scores, so that the identified issue-categories reflect those critical aspects. Another implementation of the weightage parameter disclosed within the present subject matter is that, it is used to analyse whether two or more online-scores are provided by the same person/entity. This ensures that multiple online-scores provided by the same person/entity (especially in quick-succession to each other) are ignored, during identification of the issue-categories, with respect to each of the revenue-streams. Yet, another implementation of the weightage parameter disclosed within the present subject matter is that, it is capable of being influenced by the user's specific preferences, at the time of input or, during presentation of output. So that, the user is able to utilise, a plurality of custom filters to modulate the weightage parameters as per their desire, in order to gain specific perspectives and insights, with respect to the identified issue-categories, their related generated recommendations and/or the estimated future-loss respectively, as is known within the art. Particularly it must be noted that, in other instances the specific rate may be identified, based on the deviation of the sporadicity of the online-scores, with respect to, an expected/estimated/average time-period for that specific type of online-score, as is known within the art.

The term “super-categories” or “assignment of issue-categories” refers to the act of superficial grouping, of all the plurality of identified issue-categories with respect to each of the desired revenue-streams. This superficial grouping is necessary in order to provide the user with easy access to pertinent details of the issue-categories, in various different perspectives/point-of-views, enabling the user to take a well-informed decision with respect to, each of the desired revenue-stream/s. This assignment of the various identified issue-categories, into these super-categories, is performed by the internal proprietary logic based on one or more predefined criterion. In other words, the predefined criterion is selected by the user, from among various appropriate categorization/filtration options, as is known within the art, in order to enable real-time interactive data-models for the user to interact. In some of the embodiments of the present subject matter, since the issue-categories are assigned into the super-categories, this enables the user to also access, all the related data/information, with respect to each of these identified issue-categories. Meaning that, the generated recommendations, the accurate expenditure, the estimated future-loss, booking information, etc., with respect to each of the identified issue-category, are also assigned the same super-categories as their respective issue-category, this enables and empowers the user to compare, contrast, filter and deeply-analyse, the variety of nuances that is provided by all this identified, generated and estimated data/information. In some embodiments of the present subject matter, the predefined criterion comprises, but is not limited to, return-on-investment, budget-limited, time-bound, comparative-analysis, potential-revenue-lost, impact-level, level-of-urgency, level-of-expectedness and other such custom criterion as per the user's desire. The term “return-on-investment” refers to the criterion where, the cost incurred by each of the generated recommendations, is/are compared, with the estimated cost of future-loss if that recommendation is disregarded, in order to obtain a list of ascending/descending order of the comparison values. This for example, enables a user to choose the most appropriate issues to be fixed first, that yield the highest returns with respect to the investment expended for mitigating the issue. The term “budget-limited” refers to the criterion where, the cost incurred by each of the generated recommendations, is/are compared, with the budget-constraint of the user, in order to obtain a list of issue-categories in an ascending/descending order of investment that needs to be expended. This for example, enables a user to choose the most appropriate issues to be fixed first, that are within the budget of the user for mitigating the issue. The term “time-bound” refers to the criterion where, the time incurred by each of the generated recommendations, is/are compared, with the time-constraint of the user, in order to obtain a list of issue-categories in an ascending/descending order of time required for completion. This for example, enables a user to choose the most appropriate issues to be fixed first, that are within the time-limits of the user for mitigating the issue. The term “comparative-analysis” refers to the criterion where, the cost, time, skills-needed, difficulty-level, etc. that is required by each of the generated recommendations for mitigating the identified issue-category, is/are compared, with the estimated cost of future-loss if that recommendation is disregarded, in order to obtain a list of ascending/descending order of the comparative values as per the user's desire, either cumulatively or individually. This for example, enables a user to choose the most appropriate issues to be fixed first, that yield the highest returns with respect to the investment/time/energy expended for mitigating the issue. Further, this criterion of comparative-analysis also allows the user to define any parameters, that are of interest. Furthermore, in some embodiments of the present subject matter, the comparative-analysis criterion allows the user to compare each of the issue-categories, their recommendations and/or the future-loss incurred if disregarded, across a plurality of desired revenue-streams at the same-time, in order to provide the user significantly deep comparative insights. The term “impact-level” refers to the criterion where, the impact incurred by each of the generated recommendations, is/are compared, with the current star-rating, or, other point-based rating they contribute to, in order to obtain a list of ascending/descending order of the comparison values. This for example, enables a user to choose the most appropriate issues to be fixed first, that yield the highest positive impact on the online-scores, when that issue-category is mitigated by the user. The term “potential-revenue-lost” refers to refers to the criterion where, the estimated cost of future-loss if that recommendation is disregarded is compared for the various generated possible recommendations that are generated, in order to obtain a list of ascending/descending order of the comparison values. This for example, enables a user to choose the most appropriate issues to be fixed first, that has the highest impact, in terms of incurring a future-loss for that revenue-stream. The term “level-of-urgency” refers to refers to the criterion where, the urgency-level of each of the generated recommendations, is/are compared, in order to obtain a list of ascending/descending order of the comparison values. This for example, enables a user to choose the most urgent issues to be fixed first, that yields the highest benefits after mitigating the issue. Generally, this criterion of level-of-urgency, is divided broadly into four sub super-categories, that comprise of, but are not limited to, suggestions, deficiencies, rectifications and immediate-actions. The term “level-of-expectedness” refers to the process of assigning issue-categories into two distinct portions, namely typical and non-typical issue-categories. Further, the typical issue-categories may be pre-defined/standardised categories, that are available for almost all types of revenue-stream in that domain, such as for e.g. in case of a revenue-stream where it is a real-estate property, then the issues such as, but not limited to, plumbing, electrical, etc. would form the typical issue-categories. Furthermore, the non-typical categories may be real-time/specific issue-categories, that are identified specifically for that particular revenue-stream and is/are not a common feature or issue-category for most revenue-streams in that domain. Essentially these are unique issues, like for example continuing the previous example of the revenue-stream being a real-estate property, then in that case issue-categories such as, but not limited to, issues with elevators, swimming pool issues, terrace-garden related issues, Issue with the chandelier, stained-glass window issues, etc. would form the non-typical issue-categories.

The term “suggestions” refers to the class of issue-categories, which may be overlooked, as they may not have a significant enough impact on the overall rating (online-score) of the revenue-stream. The suggestions are considered to be consisting of those, issue-categories, their related recommendations and/or the future-loss respectively, which rank an absolute-lowest in terms of urgency, with respect to that revenue-stream. These suggestions include advices/additional-features to improve a revenue-stream, provided by any of the past user, patron, client, etc. of that revenue-stream, however these have a negligible amount of impact on improving the online-score of that revenue-stream. The term “deficiencies” refers to the class of issue-categories, which should not be overlooked, as they may not have a significant enough impact on the overall rating (online-score) of the revenue-stream, however, these issue-categories exhibit a significant indirect impact on the overall rating (online-score) of the revenue-stream. The deficiencies are considered to be consisting of those, issue-categories, their related recommendations and/or the future-loss respectively, which rank medium to low in terms of urgency, with respect to that revenue-stream. The term “rectifications” refers to the class of issue-categories, that need attention on the part of the user, owner, buyer, renter, tenant, etc. of that revenue-stream, as they have a significant impact on the overall rating (online-score) of the revenue-stream, however, these issue-categories do not require an absolutely immediate attention. The rectifications are considered to be consisting of those, issue-categories, their related recommendations and/or the future-loss respectively, which rank high to medium in terms of urgency, with respect to that revenue-stream. The term “immediate-actions” refers to the class of issue-categories, that require an immediate/urgent action (primarily with the expectation of increasing the rating of the revenue-stream) on the part of the user, owner, buyer, renter, tenant, etc. of that revenue-stream, as they have a more than significant impact on the overall rating (online-score) of the revenue-stream, hence these issue-categories require an absolutely immediate attention. The immediate-actions are considered to be consisting of those, issue-categories, their related recommendations and/or the future-loss respectively, which rank the highest in terms of urgency, with respect to that revenue-stream.

The term “accurate expenditure” is referring particularly to the broad-estimates of the recommendations, that are generated with respect to each of the identified issue-categories, of each of the desired revenue-streams. The internal proprietary logic generates an accurate expenditure for conducting an amendment, with respect to each of the identified issue-category, wherein the amendment if implemented is intended, to overcome at least a portion of the negative-aspects analysed within the obtained online-scores. The accurate expenditure, comprises but is not limited to, project-plan (Proposal, roadmap, tentative-phases of the amendment, required personnel as well as their skills, plurality of plans based on the budget/time, list of available personnel, etc.), skill-estimate (skill needed to accomplish the amendment, including, number of personnel, rough amount of man-hours, level of skills required, etc. in detail), time-estimate (time needed to accomplish the amendment, including, estimated time for logistics, manufacturing, fabricating, producing, generating, training, etc in detail), cost-estimate (including but not limited to, individual component costs, cost of processes, salary/compensation to selected personnel, etc.) and/or other paraphiliac documentation with respect to that issue-category, that is being addressed by the proposed recommendation.

The term “intensive-technical-review” is referring to the act of booking an intensive-technical-review, for gaining a detailed recommendation, for all the user desired issue-categories with respect to each of the desired revenue-stream/s. The intensive-technical-review, is an appointment with an expert within that field, that provides the user, owner, buyer, renter, tenant, manufacturer, provider, etc. of that revenue-stream, a chance to gain a professional opinion from an industry-expert either physically/virtually, when it comes to implementing the generated recommendations with respect to that particular issue-category, that has been selected by the user. After this appointment has concluded, the user further has the option to hire the industry-expert, or, even book another appointment with another industry-expert from a list of curated available industry-experts, in order to mitigate that issue-category, of any of the user desired revenue-stream/s. In case, the review process entails physical appointment (by a technical/industry expert), a thorough physical inspection of the revenue-stream is conducted by the technical specialist (or, industry-expert). Furthermore, in some other cases, new data/information may be remotely obtained during the virtual appointment, with respect to the issue-category in real-time, in order for the industry-expert to re-assess the risks posed by that particular issue-category, with more precision while magnifying the accuracy level of the analysis towards that issue-category.

The term “mandatory issue-categories” refers to the ability of the user, to define one or more mandatory issue-categories during the input process, with respect to each of the said revenue-streams. This enables the user to make sure certain issue-categories of interest to the user, are prominently analysed by the method and system of the present subject matter, with respect to each of the user desired revenue-streams.

The term “intelligible sentence-form” refers essentially to a human-understandable sentence, summarizing the various information. In some embodiments of the present subject matter, the intelligible sentence-form and its content is purely dependent upon, the inputs of the user and the various selections of criterions/parameters made by the user, in order to provide critically detailed information in an easily understandable form. This information cannot be obtained by the user easily online, which is further presented to the user in a simple and clear form, such that it is understandable by a user having no technical knowledge, with respect to each of the specific revenue-stream, or, the various identified issue-categories with respect to that revenue-stream, or, even how that revenue-stream operates.

The term “central server” refers to a primary computing-platform where the textual-analysis process and the internal proprietary logic operate, in order to analyze/process the various inputs and outputs, described within the present subject matter. The method and system of comparison of real-estate data, uses the central server, in order to obtain input from a user device, as well as, public/non-public real-estate data-sources and after processing all the data, it presents the various outputs to the user device. Examples of the user device includes, but not limited to, any hand-held/wearable/desktop computing device, web-portal, website, software/mobile application, etc. while having connectivity/access with/to the central server. Further, it would be obvious to a person skilled in the art, that the central server incorporates within it, several known electronic and electrical components/architectures, in order for it to be capable of performing all the tasks and processes, as described in the present subject matter. Furthermore, it is very reasonable to assume based on the current knowledge within the art that, such a central server may be accessible to the users, via a website or an application, through any kind of user computing device/mode.

The term “real-estate unit” or simply “real-estate” refers to any kind of property. This property includes, but is not limited to any, house, building, villa, apartment, mansion, chalet, resort, industrial plant, workshop, shop, cubicle, office-space, venue, theme-park, hall, club, field, other constructions/infrastructures, any human-dwelling, or the like, as is known within the art.

The term “real-estate data” is referring to any and all kind of information/data, regardless of the depth of details, relating to a property or real estate unit. This real-estate data, comprises of, but not limited to, age, location, area, restrictions, amenities, sale price (old, current and/or predicted), construction cost, connectivity with public utilities, convenience, plumbing data, electrical data, builder/constructor data, service orders/requests, repairs/maintenance, historical data, reviews/comments regarding the property from repairmen, service men, builders, tenants, internal assessments, cost of square-foot for lease/rent, etc. regarding the property, or the like, as is known within the art. Further, this real-estate data in some embodiments may even amount to more than 5000 lines of data/information, with over 15000 data-points that are utilised for identification of the various issue-categories, of this real-estate data for any desired real-estate unit. Furthermore, in some embodiments, the owner may choose to input numerous real-estate units, as the desired revenue-streams, in such cases, the method and system of the present subject matter, apart from the other features that are described above, also allows the user to compare the various outputs with respect to each of the desired real-estate units, such as, but not limited to, the issue-categories, the recommendations, super-categories, estimated future-loss, accurate expenditure for conducting an amendment, etc., in between all these desired real-estate units.

### Exemplary Embodiments of the System and Method for Analysing Rating-Based Impact, are Defined Below

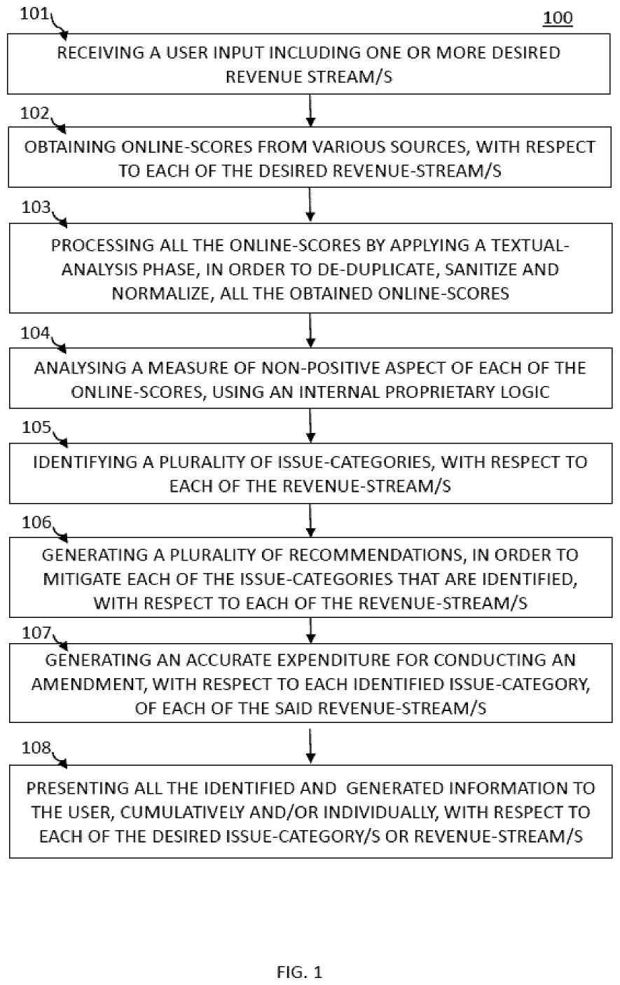

In a first exemplary embodiment of the present subject matter, as disclosed within FIG. 1. As disclosed within FIG. 1 of the present subject matter, it provides a primary embodiment of the system and method for analysing rating-based Impact, on one or more revenue-stream/s of interest. Specifically, FIG. 1 depicts a schematic view of a primary exemplary embodiment of a method 100 for executing upon the request from a user, a retrieval of online-scores, with respect to each of the desired revenue-stream/s, in order to identify the issue-categories for each of these desired revenue-stream/s and generate recommendations with respect to each of these identified issue-categories, as described herein.

In one exemplary embodiment of method of using the system for analysing rating-based Impact on one or more revenue-stream/s 100, comprises at least a central server, that is employed for a textual analysis phase and data processing by the internal proprietary logic. This central server receives 101 a user input, in the form of one or more desired revenue-stream/s, that is/are of interest to the user. In any embodiments of the present subject matter, the user computing device may include but not limited to, any suitable user computing device, such as a smart-phone, tablet, laptop computing device, desktop computing device, wearable devices (e.g., “smart glasses,” “smart watch,” etc.), and/or any other user computing devices with access to the server. Upon receiving inputs from a user with respect to one or more desired revenue-stream/s, the server obtains 102 all available online-scores from various sources, with respect to each of the desired revenue-stream/s, including various public/non-public data-sources available to the server, such as but not limited to, websites, applications, online-scores, internal reviews, capex, stock-market, business trackers, building owners, general ledgers, capital plans, budgets, service order records/requests, feedback-forms, feedback-databases, Comments, Sub-comments, memes, GIFs, reviews, mentions, news and any of the combinations thereof, as known within the art, in order to obtain any/all kind of ratings, rankings, star-ratings, reviews, comments, check-box style feedback, critique reviews, internal reviews, feedback calls/forms, silent reviews, customer/user feedback, news/review articles, newspapers, magazines, social-media reviews, mentions, memes, GIFs, other similar data that is generated by past users/patrons of that specific revenue-stream. The server then initiates processing 103 the online-scores obtained by applying a textual-analysis phase to all the acquired/captured data, in order to in order to de-duplicate, sanitize and normalize, all the obtained online-scores. These online-scores with respect to each of the desired revenue-stream/s is then provided to an internal proprietary logic for further processing this obtained data. The internal proprietary logic analyses 104 a measure of non-positive aspect, of each of the online-scores, with respect to each of the desired revenue-stream/s. Specifically, the server then with the help of the internal proprietary logic identifies 105, a plurality of issue-categories, with respect to each of the desired revenue-stream/s, as a first output to the user. The server then proceeds to generate 106, a plurality of recommendations, in order to mitigate each of the issue-categories that are identified, with respect to each of the revenue-stream/s, as a second output to the user. Further, at this juncture, some embodiments of the present subject matter, also undergo another generating step/process 107, to generate an accurate expenditure for conducting an amendment, with respect to each identified issue-category, of each of the said revenue-stream/s. It should be noted that this step 107 is an optional step, depending on the requirement of the user. Upon obtaining the above data the server presents 108, the all the identified and generated information to the user, cumulatively and/or individually, with respect to each of the desired revenue-stream/s.

In any of the embodiments of the present subject matter, the internal proprietary logic measures the non-positive aspect of each of these online-scores, in order to identify the plurality of issue-categories with respect to each of the revenue-streams. This measurement of non-positive aspects of each of the online-scores, with respect to each of the revenue-streams, is accomplished by computing certain values over a pre-defined time-period, for example, an year, a decade, quarter of an year, 6 months, etc., as is made available to the server as initial inputs, wherein these certain value can be, any of the following, but not limited to, frequency of online-scores, frequency of non-positive aspects of the online-scores, percentage of non-positive aspects of the online-scores, usage-statistics, weightage-parameter and any combination of these values, as maybe appropriate. The internal proprietary logic analyses these aforementioned non-positive aspects of the online-scores with respect to each of the revenue-streams, in order to yield, a plurality of specific indicators with respect to each of the desired revenue-stream/s. These specific indicators that are yielded, is/are any of the following, but not limited to, an increase in sales, a decrease in sales, an increase in customer satisfaction, decrease in customer satisfaction, a combination of these aforementioned trends, and/or other such similar trends that are otherwise yielded, from all the available data pool. In these embodiments, the internal proprietary logic utilises the measured non-positive online-scores and the yielded specific indicators, with respect to each of the said revenue-streams, in order to, identify the plurality of issue-categories, with respect to each of the said revenue-stream/s.

Further, in any of the embodiments of the present subject matter, the internal proprietary logic in an intermediary additional step, assigns all the identified plurality of issue-categories, into a plurality of super-categories, based on one or more predefined criterion. This criterion is, any of the following criterion, but is not limited to, a return-on-investment, a budget-limited, a time-bound, a comparative-analysis, an impact-level, a potential-revenue-lost, a level-of-urgency, a level-of-expectedness and any combination of these criterion, as maybe appropriate. This enables a user to prioritize the various identified issue-categories, as per a plethora of desired criterion, these criterion may be predefined as disclosed above, or, be a completely new custom criterion defined by the user, either way this in turn allows for various types of Information-comparison opportunities for the user, before physically initiating any of the generated recommendation. In an instance, when the criterion of assignment, is based on the level-of-urgency criterion, then the basic super-categories for all the identified issue-categories, are most likely, for example, but not limited to, suggestion, deficiencies, rectifications and immediate-actions, wherein, the suggestions would have the least priority assigned to them, while the immediate-actions would have the highest priority assigned to them. In other instance, when the criterion of assignment, is based on the level-of-expectedness criterion, then the basic super-categories for all the identified issue-categories, are most likely, for example, but not limited to, typical and non-typical, wherein the typical issue-categories would have the least priority assigned to them based on them being expected, while the non-typical issue-categories would have the highest priority assigned to them based on the fact that they are not expected at all.

Furthermore, in yet other embodiments of the present subject matter, the user has the ability to define one or more, mandatory issue-categories during initial input, with respect to any of the desired revenue-stream/s, in order to be able to access the impact analysis of the online-scores and the related recommendations, with respect to, these mandatory issue-categories.

Moreover, in yet other embodiments of the present subject matter, the user is provided with specific recommendations, with respect to each of the identified issue-categories, that also includes an accurate expenditure, which incorporates details, such as, but not limited to, a project-plan, a skill-estimate, a time-estimate, a cost-estimate, etc.

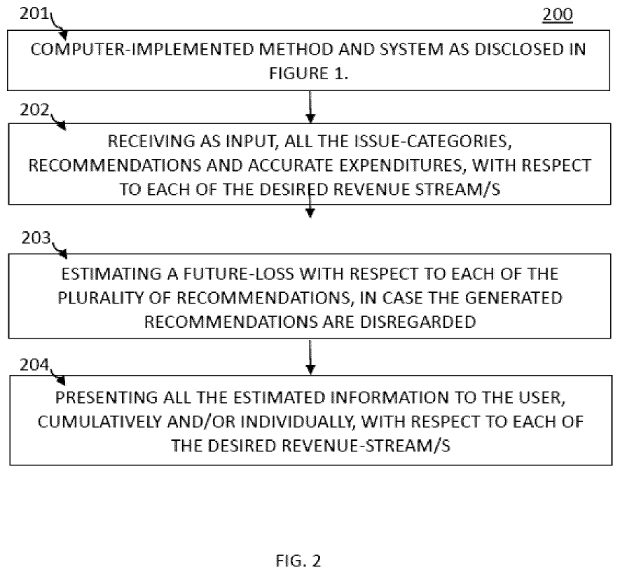

Further, as disclosed within FIG. 2 of the present subject matter, a secondary embodiment of the system and method for analysing rating-based Impact, on one or more revenue-stream/s of interest. Specifically, FIG. 2 depicts a schematic view of a secondary exemplary embodiment of a method 200 for executing upon request from a user, to provide an estimation of the future-loss incurred, with respect to each of the revenue-streams, in case the possible recommendations are not carried out, within a prescribed time-period.

In a second exemplary embodiment of method of using the system for analysing rating-based Impact 200, comprises at least a central server, that is employed for a textual analysis phase and data processing by the internal proprietary logic. First, the method/system 100 as described in FIG. 1 of the present subject matter above, is followed by the central server, encompassing the first step 201 of this method 200, in order to obtain as a first & second output for the user, all the identified and generated information, cumulatively and/or individually, with respect to each of the desired revenue-stream/s, as described previously. Pursuant to this, the server then receives 202, all the information generated in step 201 as an input for further processing the data, by the internal proprietary logic. An estimation 203 is provided by the internal proprietary logic, that includes an amount of expected future-loss, with respect to each of the plurality of recommendations, assuming that each of these generated recommendations are disregarded by the user. After which, the server provides/presents 204, all the estimation information to the user, cumulatively and/or individually, with respect to each of the desired, issue-category/s or revenue-stream/s, as a third output to the user.

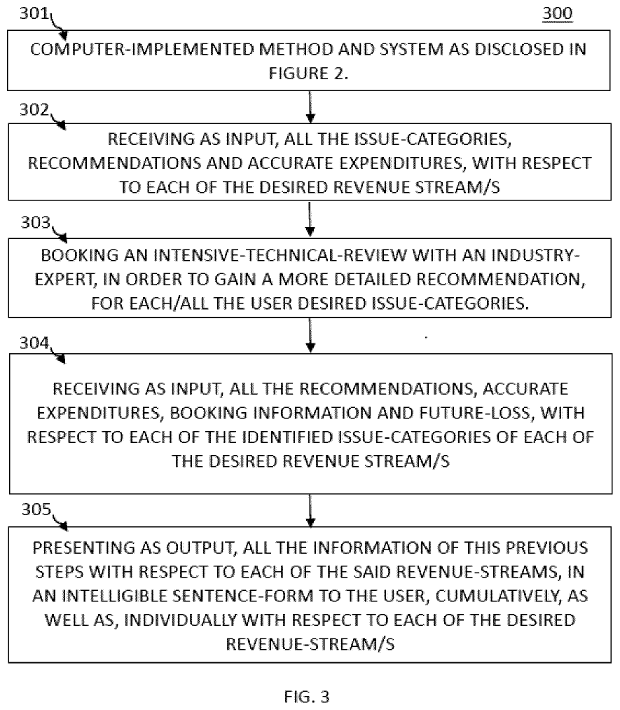

Furthermore, as disclosed within FIG. 3, of the present subject matter, a tertiary embodiment of the system and method of using the system for analysing rating-based Impact, on one or more revenue-stream/s of interest. Specifically, FIG. 3 depicts a schematic view of a tertiary exemplary embodiment of a method 300 for executing upon request from a user, in order to, first facilitates the booking of an intensive-technical-review with an industry-expert, and then, consequently provides the user with all information in an intelligible sentence-form, as described herein.

In a third exemplary embodiment of method of using the system for analysing rating-based Impact 300, comprises at least a central server, that is employed for a textual analysis phase and data processing by the internal proprietary logic. The method/system 200 as described in FIG. 2 of the present subject matter is followed by the server, encompassing the first step 301 of the method 300, in order to obtain as a first, second & third output for the user, all the identified, generated and estimated information, cumulatively and/or individually, with respect to each of the desired revenue-stream/s, as described previously. Pursuant to this, the server then receives 302 all the information generated in step 301, as well as, generates an accurate expenditure, with respect to each of the desired revenue stream/s, in order to then, provide all this information as an input for further processing the data, by the internal proprietary logic. Essentially, the first output, second output and third output, are considered as inputs for the next process, in order to, assist the user in booking 303 of an intensive-technical-review with an industry-expert, in order to gain a more detailed recommendation, for each/all the user desired issue-categories, with respect to each of the desired revenue-stream/s. Pursuant to this, the server then receives 304, all the above identified, generated, estimated and booking information, including, but not limited to each of the, issue-categories, recommendations, accurate expenditure, future-loss, intensive-technical-review, etc., with respect to each of the desired revenue-stream/s, as an input for further processing the information, by the internal proprietary logic. All these received information is then presented 305 by the server, as a fourth output to the user, all the information of this previous steps with respect to each of the said revenue-streams, to the user, cumulatively, as well as, individually with respect to each of the desired revenue-stream/s. Further, in any of the embodiments of the present subject matter, the various outputs are processed by the server, as an alternative step 305, in order to, specifically provide the user an output in an intelligible sentence-form, for ease of understanding. This intelligible sentence-form of output, in yet other embodiments, incorporates all the previous four output information, to make it available and enable, the user to essentially chat, with the server to gain all this necessary insight/information with respect to each of the desired revenue-stream/s, in a conversate method.

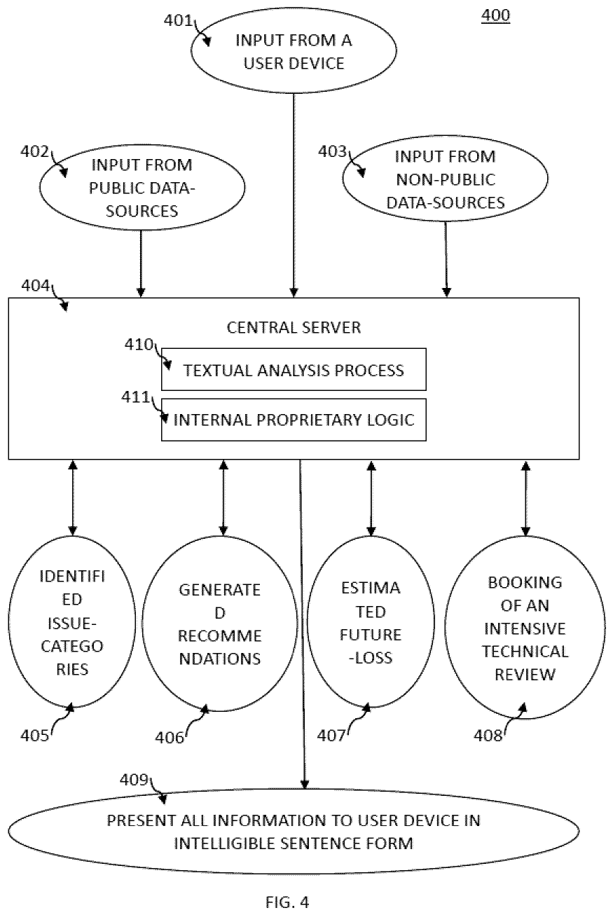

Lastly, as disclosed within FIG. 4, of the present subject matter, an essential-component block-diagram of the system and method of using the system, for analysing rating-based Impact, on one or more revenue-stream/s of interest. Specifically, FIG. 4 depicts a schematic view of the major components in an exemplary embodiment of a method 400 for executing upon request from a user, for determining the impact of online-scores on one or more desired revenue-stream/s and generating actionable recommendations in order to mitigate each of the issue-categories that are identified, with respect to each of the revenue-stream/s, as described herein.

In any embodiment of the method of using the system for analysing rating-based Impact 400, which comprises at least a central server 404, that incorporates a textual analysis phase 410 and internal proprietary logic 411 for all types of data/information processing, that is received in the form of a user input 401, essentially providing one or more desired revenue-stream/s. The central server 404, initiates the process after it receives, an input from the user device 401, as described above. After receiving this input, the central server 404 obtains all available online-scores from various sources, with respect to each of the desired revenue-stream/s, including various public/non-public data-sources available to the server, such as but not limited to, websites, applications, online-scores, internal reviews, capex, stock-market, business trackers, building owners, general ledgers, capital plans, budgets, service order records/requests, feedback-forms, feedback-databases, Comments, Sub-comments, memes, GIFs, reviews, mentions, news and any of the combinations thereof, as known within the art, in order to obtain any/all kind of ratings, rankings, star-ratings, reviews, comments, check-box style feedback, critique reviews, internal reviews, feedback calls/forms, silent reviews, customer/user feedback, news/review articles, newspapers, magazines, social-media reviews, mentions, memes, GIFs, other similar data that is generated by past users/patrons of that specific revenue-stream. These various sources, include two types of sources, public data-sources 402 and non-public data-sources 403, as per, the requirement for its data-processing needs from time to time, or, the express desire of the user, relative to the progress of the method as performed by the system. The central server 404, upon processing of this data, as explained previously in the above embodiments, provides a first output 405, a second output 406, a third output 407 and a fourth output 408. Here, the first output 405 is all the identified issue-categories with respect to each of the desired revenue-stream/s, the second output 406 is all the generated recommendations with respect to each of these identified issue-categories, the third output is the estimated future-loss with respect to each issue-category/revenue-stream if the recommendation is disregarded, and the fourth output is the booking information of an intensive-technical-review. These four outputs are even used as further inputs within some embodiments of the present subject matter. Lastly, all these four types of outputs are presented to the user, as an intelligible sentence-form 409. This ensures, that a user with very little technical experience may harness the power of computer-based data-processing, in order to gain deep unique insights regarding the one or more desired revenue-stream/s, which would otherwise be impossible.

Effectuating the method and system, disclosed above, certain exemplary embodiments of user interactions, have been provided below:

For example, in one of the exemplary embodiments of the present subject matter, the user is interested in a hotel that he/she owns, which has a lot of problems due to a lack of funding for several years including during covid, where no funding was allocated generally to any kind of mending/fixing anywhere. So, current situation is that, the issues that needed to be repaired before covid were pending, but they were deferred through covid, and now all those issues are still pending and more newer ones have cropped up as time passes. Now the problem is that every hotel says they have huge problems due to the pandemic. However, the user does not need to just acknowledge all the problems, but also ascertain that the problems that need to be solved have caused a huge drop in revenue over time, because of consistent poor ratings online. This is where this method and system, of the present subject matter shines brightest, as it enlightens the user, with respect to each impactful issue based on the various obtained online-scores, with respect to that hotel. Further, since the system and method, also provide relevant recommendation with respect to each of these identified issues and a clear picture, of the amount of losses to the revenue, if these recommendations are not applied, to improve the hotel. Furthermore, in yet other exemplary embodiments, some user may have multiple hotels, in such instances, they may employ the system and method, as described above, and then go beyond to compare, these various issues, recommendations and the estimated future-loss of each, with respect to each of these hotels, with each other, in order to arrive at the best issues to resolve first in order to increase the revenue the quickest, by directly influencing the online-scores, pursuant to the regarding and amending the provided recommendations to overcome the selected identified issues.

Continuing with the forgoing example, in some preferred embodiments of the present subject matter, these issues may form an integral part, that tie the loss in ratings, to the building related issues, such as, but not limited to, HVAC not working in meeting rooms, or, running out of hot water. That kind of an issue causes a lot of bad reviews quickly, as hot water is considered a basic amenity these days, in the hotel business. Hence, the system and the method allow the user to analyse, all the bad reviews and identify what exactly is the root-problem, that is causing the downward trend of ratings. Further, upon processing the system/method, find all of the bad HVAC room issues, bad HVAC conference area issues, bad HVAC common area issues, and groups them together, as an issue-category. Same for a lack of hot water, etc. and provides, appropriate recommendations to the user, with respect to each of these identified issue-categories. Then next, in some embodiments, it goes on to compute the cost of the bad reviews based over the time period, normalizes the data to a yearly basis and computes the loss of revenue per year for each item. Furthermore, it should be noted that, hotels for example typically see 90% of the bad building related reviews for the guestrooms, followed by conference areas for larger hotels. This information is utilised by the system and method to create the exact impact to revenue from all of the bad reviews for the hotel guestroom HVAC. Once again, if a site shows the impact of bad reviews for HVAC guestrooms, this adds even more confirmation to the prior argument (the prior argument of decreased revenue based on star rating alone), to show ownership that the reduced revenue is because of guestroom HVAC and the impact is for example, $538,174 annually.

When the system/method is on a case like the above, one of the prime objectives is to identify all of the different facets in order to be able to present owner/user with the most compelling issues/issue-categories. So that, all possible facets that impact the revenue-stream are aptly identified and presented to the user. Although, it should also be noted that, in the above example, it is very possible that the overall star rating of the hotel may remain unchanged even after applying the recommendations, but maybe the Guestroom HVAC reviews have greatly increased over time, that form a subset of the total reviews (online-scores), in that instance maybe. However, this surely would only increase profits for the hotel, rather than diminish them, like before.

While this specification contains many specific implementation details, these should not be construed as limitations on the scope of any implementations, or, of what may be claimed, but rather as descriptions of features specific to these particular embodiments of particular implementations of the system, described here. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub combination or variation of a sub combination.

Similarly, while methods/operations are depicted in the drawings in a particular order, this should not be understood as requiring that such operations be performed in the particular order shown or in sequential order, or that all illustrated operations be performed, to achieve desirable results. Moreover, only particular embodiments of the subject matter have been described, here. Other embodiments are within the scope of the following claims. In some cases, the actions recited in the claims is performed in a different order and still achieve desirable results. In addition, the processes depicted in the accompanying figures do not necessarily require the particular order shown, or sequential order, to achieve desirable results. Below provided, are the claims pertaining, to this present subject matter:

1. A computer-implemented method, for analysing rating-based Impact, comprising the steps of:
a) Receiving input from a user with respect to one or more revenue-streams;
b) Obtaining a plurality of online-scores from various sources, with respect to each of the revenue-stream;
c) Analysing a measure of non-positive aspect of each of the online-scores, in order to identify a plurality of issue-categories with respect to each of the revenue-stream; and
d) Generating a plurality of recommendations, in order to mitigate each of the issue-categories that are identified, with respect to each of the revenue-streams.

2. The computer-implemented method, for analysing rating-based Impact, as claimed in claim 1, further comprises the steps of:
Estimating a future-loss with respect to each of the plurality of recommendations, when the said recommendations are disregarded.

3. The computer-implemented method, for analysing rating-based Impact, as claimed in claim 2 further comprises the steps of:
Presenting to the user as one of the outputs, the plurality of recommendations and the estimated future-loss with respect to each of the plurality of recommendations.

4. The computer-implemented method, for analysing rating-based Impact, as claimed in claim 3 further comprises the steps of:
Presenting to the user as one of the outputs, the plurality of recommendations and the estimated future-loss, are presented in at least one form of:
a cumulative amount for the whole of each revenue-stream; and
a plurality of individual amounts, with respect to each of the plurality of issue-categories.

5. The computer-implemented method, for analysing rating-based Impact, as claimed in claim 1, wherein:
the obtaining step has two distinct phases, first a collection phase acquires the plurality of online-scores with respect to each of the said revenue-streams; and
then followed by a textual-analysis phase that de-duplicates, sanitizes and normalizes, all the obtained online-scores.

6. The computer-implemented method, for analysing rating-based Impact, as claimed in claim 1, wherein:
the analysing step utilises, an internal proprietary logic for measuring the non-positive aspect of each of these online-scores, in order to identify the plurality of issue-categories, with respect to each of the revenue-stream/s.

7. The computer-implemented method, for analysing rating-based Impact, as claimed in claim 6, wherein the internal proprietary logic analyses the measure of non-positive aspects of the online-scores with respect to each of the revenue-streams, by computing certain values over a pre-defined time-period, wherein the certain value is, at least one of:
a frequency of online-scores;
a frequency of non-positive aspects of the online-scores;
a percentage of non-positive aspects of the online-scores;
a usage-statistics; and
a weightage-parameter.

8. The computer-implemented method, for analysing rating-based Impact, as claimed in claim 6, wherein the internal proprietary logic analyses the non-positive aspects of the online-scores with respect to each of the revenue-stream/s, in order to yield a plurality of specific indicators.

9. The computer-implemented method, for analysing rating-based Impact, as claimed in claim 8, wherein the plurality of specific indicators that are yielded are, at least one of:
an increase in sales;
a decrease in sales;
an increase in customer satisfaction; and
a decrease in customer satisfaction.

10. The computer-implemented method, for analysing rating-based Impact, as claimed in claim 8, wherein:
the internal proprietary logic utilises the measured non-positive online-scores and the yielded plurality of specific indicators, with respect to each of the said revenue-stream/s, in order to identify the plurality of issue-categories with respect to each of the said revenue-stream/s.

11. The computer-implemented method, for analysing rating-based Impact, as claimed in claim 10 further comprises the steps of:
assigning the identified plurality of issue-categories, into a plurality of super-categories by the internal proprietary logic, based on one or more predefined criterion.

12. The computer-implemented method, for analysing rating-based Impact, as claimed in claim 11 wherein, the one or more predefined criterion, is at least one of:
a return-on-investment,
a budget-limited,
a time-bound,
a comparative-analysis,
a potential-revenue-lost,
an impact-level,
a level-of-urgency, and
a level-of-expectedness.

13. The computer-implemented method, for analysing rating-based Impact, as claimed in claim 12,
wherein the plurality of super-categories based on the level-of-urgency criterion, is at least one of:
suggestions;
deficiencies;
rectifications; and
immediate-actions.

14. The computer-implemented method, for analysing rating-based Impact, as claimed in claim 12,
wherein the plurality of super-categories based on the level-of-expectedness criterion, is at least one of:
a typical issue-category; and
a non-typical issue-category.

15. The computer-implemented method, for analysing rating-based Impact, as claimed in claim 10 wherein the generating step utilises the internal proprietary logic to generate the plurality of recommendations with respect to, each of the issue-categories of each of the said revenue-streams/, includes:
generating an accurate expenditure for conducting an amendment with respect to, each of the identified issue-category of each of the said revenue-stream/s.

16. The computer-implemented method, for analysing rating-based Impact, as claimed in claim 15, wherein the accurate expenditure, is at least one of:
a project-plan,
a skill-estimate,
a time-estimate, and
a cost-estimate.

17. The computer-implemented method, for analysing rating-based Impact, as claimed in claim 16 further comprises the steps of:
booking an intensive-technical-review, for gaining a detailed recommendation, for all the user desired issue-categories.

18. The computer-implemented method, for analysing rating-based Impact, as claimed in claim 17 further comprises the steps of:
presenting as output, all information with respect to each of the said revenue-stream/s, in an intelligible sentence-form to the user.

19. The computer-implemented method, for analysing rating-based Impact, as claimed in claim 15 further comprises the steps of:
Estimating a future-loss with respect to each of the plurality of recommendations, when the said recommendations are disregarded.

20. The computer-implemented method, for analysing rating-based Impact, as claimed in claim 1 further comprises the steps of:
defining one or more mandatory issue-categories during the input process, with respect to each of the said revenue-stream/s.
